(19) United States
(12) Patent Application Publication
(10) Pub. No.: US 2024/0092646 A1
(43) Pub. Date: Mar. 21, 2024

(54) AMMONIA MANUFACTURING APPARATUS AND AMMONIA MANUFACTURING METHOD

(71) Applicant: JGC CORPORATION, Kanagawa (JP)

(72) Inventors: Hiroyuki ISOBE, Kanagawa (JP); Yasushi FUJIMURA, Ibaraki (JP); Mototaka KAI, Kanagawa (JP); Yuki HOSHINO, Kanagawa (JP); Keisuke NARITA, Kanagawa (JP)

(73) Assignee: JGC CORPORATION, Kanagawa (JP)

(21) Appl. No.: 18/273,549

(22) PCT Filed: Jan. 27, 2021
(86) PCT No.: PCT/JP2021/002731

§ 371 Date: Jul. 21, 2023

(51) Int. Cl. C01C 1/04; B01D 53/04; C25B 1/04; C25B 15/021

(52) U.S. Cl. CPC C01C 1/0417; B01D 53/0462; C25B 1/04; C25B 15/021; B01D 2257/102; B01D 2258/06

(57) ABSTRACT

An ammonia manufacturing apparatus includes: an ammonia synthesis unit synthesizing ammonia under a chemical reaction using hydrogen and nitrogen as a raw material gas in a reactor; and a heat storage unit including a heating medium. The heat storage unit can supply heat from the heating medium to the ammonia synthesis unit when an amount of the raw material gas supplied to the ammonia synthesis unit increases.

### TECHNICAL FIELD

The present invention relates to an ammonia manufacturing apparatus and an ammonia manufacturing method capable of using renewable energy.

### BACKGROUND ART

Conventionally, as a technique for converting renewable energy into an energy carrier, a technique for manufacturing hydrogen (H₂) by electrolysis of water using power generated by renewable energy has been proposed. However, hydrogen has a low boiling point, is not easily liquefied, and has problems in transportation, storage, and the like.

A compound containing many hydrogen atoms (H) in a molecule thereof, such as ammonia, methane, or an organic hydride has been proposed as an energy carrier. In particular, ammonia (NH₃) is attracting attention because ammonia can be burned directly and does not emit carbon dioxide (CO₂) even if ammonia is burned.

For example, Patent Literature 1 describes that in a system for producing a nitrogen-containing compound such as ammonia or urea by reacting hydrogen generated by electrolysis of water using renewable energy with nitrogen, exhaust heat of a reactor and exhaust heat of an oxygen combustion generator are stored in a thermal energy storage device (ESS) using a molten salt, and when the renewable energy is insufficient, the heat stored in the ESS is converted into power, which is supplied to an electrolysis device.

Patent Literature 2 describes that a purge line for supplying a purge gas containing an inert gas or an inert substance such as methane is installed in an ammonia plant, and the concentration of the purge gas is increased when the load of an ammonia synthesis loop is suppressed more than usual.

Patent Literature 3 describes that a system in which a produced gas is synthesized from a first reactant gas and a second reactant gas, and an unconverted reactant gas in the produced gas is guided to a circuit is operated without being stopped by changing the volume flow rate of the reactant gas or produced gas. Examples of the reactant gas include (i) hydrogen and nitrogen, (ii) hydrogen and carbon monoxide, and (iii) hydrogen and carbon dioxide. Examples of the produced gas include ammonia, alcohol, aldehyde, ketone, carboxylic acid, and a hydrocarbon.

### CITATION LIST

### Patent Literature

Patent Literature 1: US 2020/0148547 A
Patent Literature 2: US 2013/0108538 A
Patent Literature 3: WO 2017/153304 A

### SUMMARY OF INVENTION

### Technical Problem

When ammonia is produced using renewable energy, the produced amount of hydrogen as a raw material of ammonia is also apt to fluctuate depending on the amount of power generation by the renewable energy. If a hydrogen storage facility is used, hydrogen produced when the amount of power generation is large can also be used when the amount of power generation is small. However, when the hydrogen storage facility is increased in size, a large cost is required for facility investment.

When the storage amount of hydrogen is reduced, the frequency of fluctuating the supply amount of a raw material gas and the produced amount of ammonia increases depending on fluctuation in the produced amount of hydrogen. A chemical reaction (ammonia synthesis reaction) in which 2 mol of ammonia is generated from 3 mol of hydrogen and 1 mol of nitrogen is an exothermic reaction, but a catalyst and a high temperature are generally required to cause the ammonia synthesis reaction to proceed in a gas phase, and the high temperature is maintained by heat generated by the ammonia synthesis reaction. For this reason, when fluctuation in the supply amount of the raw material gas becomes excessive, the ammonia synthesis reaction unstably proceeds, which may make it difficult to continue the operation.

An object of the present invention is to provide an ammonia manufacturing apparatus and an ammonia manufacturing method capable of manufacturing ammonia using renewable energy and suppressing the destabilization of ammonia synthesis due to fluctuation in the supply amount of a raw material gas.

### Solution to Problem

A first aspect of the present invention is an ammonia manufacturing apparatus including: an ammonia synthesis unit synthesizing ammonia under a chemical reaction using hydrogen and nitrogen as a raw material gas in a reactor; and a heat storage unit including a heating medium, wherein the heat storage unit can supply heat from the heating medium to the ammonia synthesis unit when an amount of the raw material gas supplied to the ammonia synthesis unit increases.

A second aspect of the present invention is the ammonia manufacturing apparatus according to the first aspect, further including a hydrogen production unit producing at least a part of the hydrogen supplied to the ammonia synthesis unit by electrolysis of water, wherein the hydrogen production unit uses renewable energy as at least a part of an energy source for the electrolysis.

A third aspect of the present invention is the ammonia manufacturing apparatus according to the first or second aspect, wherein the ammonia synthesis unit includes a heating medium-raw material gas heat exchanger capable of supplying heat from the heating medium to the raw material gas.

A fourth aspect of the present invention is the ammonia manufacturing apparatus according to any one of the first to third aspects, wherein the ammonia synthesis unit includes: a heating medium-produced gas heat exchanger capable of supplying heat from the heating medium to a produced gas obtained on an outlet side of the reactor; and a produced gas-raw material gas heat exchanger capable of supplying heat from the produced gas passing through the heating medium-produced gas heat exchanger to the raw material gas.

A fifth aspect of the present invention is the ammonia manufacturing apparatus according to any one of the first to fourth aspects, wherein heat can be stored in the heating medium using the produced gas obtained on the outlet side of the reactor.

A sixth aspect of the present invention is the ammonia manufacturing apparatus according to any one of the first to fifth aspects, wherein heat can be stored in the heating medium using surplus power generated by renewable energy.

A seventh aspect of the present invention is the ammonia manufacturing apparatus according to any one of the first to sixth aspects, wherein heat can be stored in the heating medium using exhaust heat of a gas turbine using hydrogen as fuel.

An eighth aspect of the present invention is the ammonia manufacturing apparatus according to any one of the first to seventh aspects, further including a hydrogen production unit producing at least a part of the hydrogen supplied to the ammonia synthesis unit by electrolysis of water, wherein the heating medium can be used as a heating source for the electrolysis.

A ninth aspect of the present invention is the ammonia manufacturing apparatus according to any one of the first to eighth aspects, further including an air separation device using temperature swing adsorption (TSA) as a nitrogen supply unit supplying the nitrogen to the ammonia synthesis unit, wherein the heating medium can be used as a heating source of the air separation device.

A tenth aspect of the present invention is an ammonia manufacturing method including: an ammonia synthesis step of synthesizing ammonia under a chemical reaction using hydrogen and nitrogen as a raw material gas in a reactor; and a heat storage step of storing heat in a heat storage unit including a heating medium, wherein the heat storage unit supplies heat from the heating medium to the ammonia synthesis step when an amount of the raw material gas supplied to the ammonia synthesis step increases.

A 11th aspect of the present invention is the ammonia manufacturing method according to the tenth aspect, further including a hydrogen production step of producing at least a part of the hydrogen supplied to the ammonia synthesis step by electrolysis of water, wherein renewable energy is used as at least a part of an energy source for the electrolysis.

A 12th aspect of the present invention is the ammonia manufacturing method according to the tenth or 11th aspect, wherein a flow rate of the raw material gas supplied to the ammonia synthesis step can be increased at a rate of 1.5% or more per minute with a flow rate set as an upper limit of an amount of the raw material gas supplied to the ammonia synthesis step as 100%.

### Advantageous Effects of Invention

According to the first aspect, the heat is supplied from the heating medium to the ammonia synthesis unit when the amount of the raw material gas supplied to the ammonia synthesis unit increases, whereby a decrease in the internal temperature of the reactor can be suppressed to stably continue an ammonia synthesis reaction.

According to the second aspect, even if the renewable energy is used as the energy of the electrolysis for producing the hydrogen from the water, the decrease in the internal temperature of the reactor can be suppressed to stably continue the ammonia synthesis reaction, so that the destabilization of ammonia synthesis due to fluctuation in the supply amount of the raw material gas can be suppressed.

According to the third aspect, the heat is supplied by heat exchange between the heating medium and the raw material gas, whereby the heat can be easily supplied into the reactor without the heating medium being introduced into the reactor.

According to the fourth aspect, heat exchange is performed between the heating medium and the produced gas, and heat exchange is then performed between the produced gas and the raw material gas, whereby the heat can be easily supplied into the reactor without the heating medium being introduced into the reactor.

According to the fifth aspect, heat produced by the ammonia synthesis reaction can be effectively utilized.

According to the sixth aspect, energy stored in the heating medium is produced using the surplus power generated by the renewable energy, whereby the surplus power can be effectively utilized.

According to the seventh aspect, by using the exhaust heat of the gas turbine as a heating source of the heating medium, the exhaust heat can be effectively utilized.

According to the eighth aspect, the heating medium is used as the heating source for electrolysis, whereby the heat of the heating medium can be effectively utilized even when there is no need to supply the heat from the heating medium to the ammonia synthesis unit.

According to the ninth aspect, the temperature swing adsorption (TSA) is used in the air separation device (ASU), whereby the heating medium can be used as the heating source of the TSA. Accordingly, even when there is no need to supply the heat from the heating medium to the ammonia synthesis unit, the heat of the heating medium can be effectively utilized.

According to the tenth aspect, the heat is supplied from the heating medium to the ammonia synthesis step when the amount of the raw material gas supplied to the ammonia synthesis step increases, whereby a decrease in the internal temperature of the reactor in the ammonia synthesis step can be suppressed to easily continue the ammonia synthesis reaction.

According to the 11th aspect, even if the renewable energy is used as the energy of electrolysis for producing the hydrogen from the water, the decrease in the internal temperature of the reactor can be suppressed to stably continue the ammonia synthesis reaction, so that the destabilization of ammonia synthesis due to fluctuation in the supply amount of the raw material gas can be suppressed.

According to the 12th aspect, the amount of the raw material gas supplied to the ammonia synthesis step can be more rapidly increased.

### BRIEF DESCRIPTION OF DRAWINGS

FIG. 1 is a conceptual diagram illustrating the outline of an ammonia manufacturing apparatus.

FIG. 2 is a configuration diagram illustrating an ammonia synthesis device of First Example.

FIG. 3 is a configuration diagram illustrating an ammonia synthesis device of Second Example.

FIG. 4 is a graph illustrating a first example of simulation results in Comparative Examples.

FIG. 5 is a graph illustrating a second example of simulation results in Comparative Examples.

FIG. 6 is a graph illustrating a third example of simulation results in Comparative Examples.

### DESCRIPTION OF EMBODIMENTS

Hereinafter, the present invention will be described with reference to the drawings based on preferred embodiments.

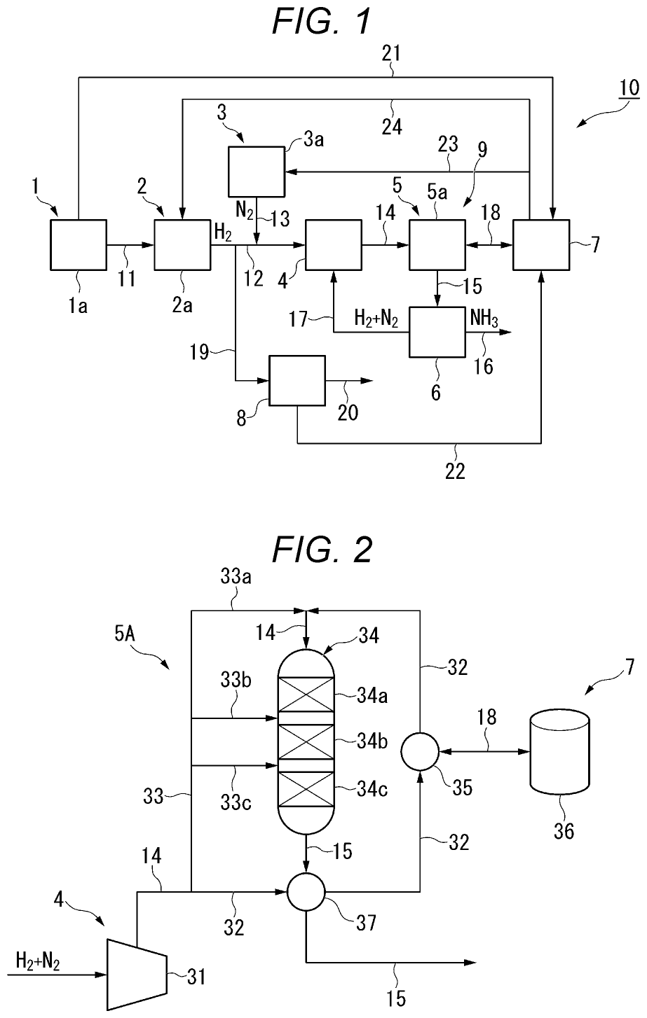

FIG. 1 is a conceptual diagram illustrating the outline of an ammonia manufacturing apparatus of the present embodiment. An ammonia manufacturing apparatus 10 of the embodiment includes an ammonia synthesis unit 9 synthesizing ammonia (NH₃) under a chemical reaction using hydrogen (H₂) and nitrogen (N₂) as a raw material gas, and a heat storage unit 7 including a heating medium 18.

An ammonia manufacturing method of the embodiment includes an ammonia synthesis step of synthesizing ammonia (NH₃) under a chemical reaction using hydrogen (H₂) and nitrogen (N₂) as a raw material gas, and a heat storage step of storing heat in a heat storage unit 7 including a heating medium 18. In the ammonia synthesis step, the ammonia synthesis unit 9 can be used.

The ammonia manufacturing apparatus 10 of the embodiment may include a hydrogen production unit 2 producing at least a part of the hydrogen supplied to the ammonia synthesis unit 9 by electrolysis of water (H₂O). In this case, the hydrogen production unit 2 includes an electrolytic device 2a electrolyzing water. The hydrogen production unit 2 can perform a hydrogen producing step of producing at least a part of the hydrogen supplied to the ammonia synthesis step by electrolysis of water.

The hydrogen production unit 2 may be installed exclusively for the ammonia manufacturing apparatus 10, or may be used for a joint purpose of a demand of the ammonia manufacturing apparatus 10 and other demands. The installation location of the hydrogen production unit 2 may be on the same site as that of the ammonia manufacturing apparatus 10, may be a location adjacent to the ammonia manufacturing apparatus 10, or may be a location away from the ammonia manufacturing apparatus 10.

It is preferable to use renewable energy as at least a part of the energy source of the electrolytic device 2a. For example, power supplied from a power source 1 including a power generation facility 1a using renewable energy may be at least a part of a power source of the electrolytic device 2a.

The power generation facility 1a may be installed as a part of the ammonia manufacturing apparatus 10. The power generation facility 1a may be installed by an electric power company different from an installer of the ammonia manufacturing apparatus 10. The power generation facility 1a may be installed exclusively for the ammonia manufacturing apparatus 10, or may be used for a joint purpose of a demand of the ammonia manufacturing apparatus 10 and other demands. The installation location of the power generation facility 1a may be on the same site as that of the ammonia manufacturing apparatus 10, may be a location adjacent to the ammonia manufacturing apparatus 10, or may be a location away from the ammonia manufacturing apparatus 10.

As the power generation facility 1a using renewable energy, variable renewable energy selected from solar power generation, wind power generation, solar thermal power generation, and ocean power generation may be used. As the power generation facility 1a using renewable energy, non-variable renewable energy such as biomass power generation, geothermal power generation, or hydropower generation may be used. In either case, the renewable energy can be used as the power source for the electrolytic device 2a.

Note that the ocean power generation is not particularly limited, and examples thereof include wave power generation using wave energy, tidal flow power generation using a horizontal flow due to tide, tidal force power generation using a tide level difference due to tide, ocean flow power generation due to horizontal circulation of seawater, and ocean temperature difference power generation due to a temperature difference between a surface layer of the ocean and the deep sea. The hydropower generation may be a canal type or a dam type, or a dam canal type in which both are used in combination.

At least a part of the power source 1 supplying power 11 to the electrolytic device 2a may be derived from power generation other than the power generation facility 1a using renewable energy. Examples of the power generation other than renewable energy include thermal power generation and nuclear power generation. The electrolytic device 2a may use power generated by power generation other than renewable energy, or may use only power generated by renewable energy. At least a part of the power source 1 may be system power supplied from another power generation company through a power system.

The power generated by the power generation other than the renewable energy may be used when the power supplied from the power generation facility 1a using the renewable energy is insufficient. The power supplied from the power generation facility 1a may be set to a certain ratio in advance, to constantly use the power generated by power generation other than the renewable energy.

When the power consumption of the electrolytic device 2a is 100%, the ratio of power from the renewable energy is, for example, 10 to 90%, but may be less than 10% or more than 90%.

The ammonia synthesis unit 9 has a function of receiving supply of a raw material gas 14 containing hydrogen 12 and nitrogen 13. The ammonia synthesis unit 9 may include a booster 4 boosting the pressure of the raw material gas 14, an ammonia synthesis device 5 synthesizing ammonia from the raw material gas 14 boosted using the booster 4, and an ammonia separation device 6 separating ammonia 16 from a produced gas 15 obtained by the ammonia synthesis device 5.

A route for obtaining the hydrogen 12 and the nitrogen 13 as the raw material gas 14 for ammonia synthesis is not particularly limited, and at least a part thereof is preferably supplied from the ammonia manufacturing apparatus 10. At least a part of the hydrogen 12 may be supplied from the hydrogen production unit 2. At least a part of the nitrogen 13 may be supplied from a nitrogen supply unit 3. The ammonia synthesis unit 9 may have a function of controlling the supply amount of the raw material gas 14. When the ammonia synthesis unit 9 receives the supply of the raw material gas 14 from another facility, the ammonia synthesis unit 9 may have a function of detecting the supply amount of the raw material gas 14.

When the produced amount of ammonia is controlled depending on the supply amount of the hydrogen 12 from the hydrogen production unit 2, it is preferable to control the supply amount of the nitrogen 13 such that the molar ratio of the hydrogen 12 and the nitrogen 13 is 3:1. The raw material gas 14 may be a mixture of the hydrogen 12 and the nitrogen 13, and an inert component for the ammonia synthesis reaction may be further added to the raw material gas 14. Examples of the inert component include argon (Ar) and methane (CH₄).

The ammonia synthesis device 5 is not particularly limited, and examples thereof include a device synthesizing ammonia in a gas phase using an ammonia synthesis catalyst under high-temperature and high-pressure conditions by known methods such as the Haber-Bosch process. The ammonia synthesis device 5 includes a reactor 5a containing an ammonia synthesis catalyst therein.

The ammonia synthesis catalyst is not particularly limited, and examples thereof include a catalyst containing iron as a main component and a catalyst containing a metal element such as ruthenium (Ru) or lanthanoid as a transition metal other than iron (Fe). The ammonia synthesis catalyst installed in the reactor 5a may be a metal oxide such as iron oxide. In this case, a chemical species generated in the reactor 5a by reduction of the metal oxide with hydrogen may exhibit a catalytic function. The ammonia synthesis catalyst may contain alumina, an alkali metal compound, or an alkaline earth metal compound or the like for the purpose of a promoter or a carrier or the like. The ammonia synthesis catalyst may be a structure in which a metal element or a metal compound is supported on a particulate or porous carrier.

The internal temperature of the reactor 5a can be appropriately set depending on the activity of the ammonia synthesis catalyst and the like. The internal temperature of the reactor 5a is not particularly limited, and is, for example, about 200 to 600° C. Equilibrally, an exothermic reaction such as an ammonia synthesis reaction easily proceeds at a lower temperature, that is, the ratio (concentration in an equilibrium state) of ammonia as a product can be increased. Therefore, it is preferable to select an ammonia synthesis catalyst having activity at a lower temperature. However, the ammonia synthesis catalyst requires a corresponding temperature to exhibit activity, and it takes time to reach an equilibrium state, whereby the internal temperature of the reactor 5a is preferably set in consideration of the reaction rate.

The produced gas 15 generated by the ammonia synthesis reaction is a mixture containing hydrogen, nitrogen, and ammonia. The produced gas 15 is transferred from the ammonia synthesis device 5 to the ammonia separation device 6. The ammonia 16 can be separated from a mixed gas 17 of hydrogen and nitrogen by the ammonia separation device 6. When a product of ammonia synthesis is used as an energy carrier, the ammonia 16 is preferably liquid ammonia.

In the ammonia separation device 6, a method of separating ammonia from the produced gas 15 is not particularly limited, and for example, the produced gas 15 may be cooled to selectively liquefy ammonia. In this case, the ammonia separation device 6 may include a cooler cooling the produced gas 15 and a gas-liquid separator separating liquid ammonia from the cooled produced gas 15. When the gas-liquid separator is used, unreacted hydrogen and nitrogen are separated in a gas phase as the mixed gas 17.

When a nitrogen compound such as ammonia water, urea, or an ammonium salt is manufactured from the synthesized ammonia, ammonia in the produced gas 15 is selectively reacted with or dissolved in water, carbon dioxide, or an acid or the like to separate the ammonia from the produced gas 15, whereby the mixed gas 17 containing unreacted hydrogen and nitrogen can also be obtained.

By returning the mixed gas 17 separated by the ammonia separation device 6 to the booster 4, the mixed gas 17 can be used as the raw material gas 14 of the ammonia synthesis device 5. When an inert component is not added to the raw material gas 14, the mixed gas 17 becomes a mixture of unreacted hydrogen and nitrogen. When the molar ratio of hydrogen and nitrogen in the mixed gas 17 is about 3:1, the mixed gas 17 can be returned to the booster 4 with the composition as it is. If necessary, processing such as removal of impurities may be performed before the mixed gas 17 is returned to the booster 4.

When the inert component is added to the raw material gas 14, the mixed gas 17 containing the inert component may be returned to the booster 4. In this case, in order to prevent the ratio of the inert component in the raw material gas 14 from becoming excessive, the composition of the inert component in the raw material gas 14 or the mixed gas 17 may be adjusted.

The ammonia manufacturing apparatus 10 of the embodiment includes the heat storage unit 7 including the heating medium 18. The heat storage unit 7 can supply heat to the ammonia synthesis unit 9 through the heating medium 18 supplied to the ammonia synthesis unit 9 when the amount of the raw material gas 14 supplied to the ammonia synthesis unit 9 increases.

The ammonia synthesis reaction is an exothermic reaction, whereby the produced heat of ammonia can be used to maintain the internal temperature of the reactor 5a. Therefore, the temperature of the raw material gas 14 is usually lower than the internal temperature of the reactor 5a. If the supply amount of the raw material gas 14 is suddenly increased from a state where the produced amount of ammonia is small, the internal temperature of the reactor 5a decreases before the produced amount of ammonia increases, which causes a possibility that a condition in which the ammonia synthesis reaction is independently operated cannot be maintained. Therefore, when heat is supplied to the ammonia synthesis unit 9 when the amount of the raw material gas 14 increases, a decrease in the internal temperature of the reactor 5a can be suppressed to stably continue the ammonia synthesis reaction.

A method of supplying heat from the heating medium 18 is not particularly limited, and for example, it is sufficient that heat can be supplied to any object included in the ammonia synthesis unit 9, to directly or indirectly supply heat into the reactor 5a. Examples of the object to which heat is supplied from the heating medium 18 include one or more of the raw material gas 14, the produced gas 15, the mixed gas 17, and the ammonia synthesis device 5 and the like.

The heating medium 18 of the heat storage unit 7 is not particularly limited as long as it is a substance having fluidity at the time of heat exchange, and a liquid substance having large specific heat is preferable. The temperature of the object to which heat is supplied from the heating medium 18 becomes relatively high depending on the internal temperature of the reactor 5a, whereby the heating medium 18 preferably has heat resistance sufficient for continuing heat exchange. For example, a molten salt or a heating medium oil or the like can be used as the heating medium 18.

Examples of the molten salt used as the heating medium 18 include one of an alkali metal salt, an alkaline earth metal salt, a fluoride, a chloride, a carbonate, a nitrate, and a nitrite and the like, or a mixture of two or more thereof. Examples of the heating medium oil include one of a hydrocarbon, an ether compound, an aromatic compound, an organofluorine compound, an organochlorine compound, a silicone compound, a mineral oil, and a synthetic oil and the like, or a mixture of two or more thereof.

Since a temperature range in which the substance used as the heating medium 18 exhibits appropriate fluidity is different from a temperature range in which the substance exhibits appropriate heat resistance, an appropriate heating medium 18 is preferably used depending on the purpose. When a mixture of two or more substances is used as the heating medium 18, the mixture may be a composition forming a uniform continuous phase, or a composition forming a dispersed phase.

For example, the heat storage unit 7 including two or more heating media 18 such as the heat storage unit 7 including the heating medium 18 for high temperature and the heat storage unit 7 including the heating medium 18 for low temperature may be used. In this case, heat exchange may be enabled between different types of heating media 18. When heat exchange is performed between the heat storage unit 7 and the ammonia synthesis unit 9, the heating medium 18 for high temperature or the heating medium 18 for low temperature may be selectively used.

From the viewpoint of stably continuing the operation of the ammonia synthesis unit 9, it is preferable to use one type of heating medium 18 between the heat storage unit 7 and the ammonia synthesis unit 9 at least during the normal operation of the ammonia synthesis unit 9. It is preferable that the heat storage unit 7 stores the stored heating medium 18 in advance, and the heating medium 18 is supplied from the heat storage unit 7 to the ammonia synthesis unit 9 when heat is supplied to the ammonia synthesis unit 9.

The heating medium 18 after heat is supplied to the ammonia synthesis unit 9 may be returned to the heat storage unit 7 to circulate the heating medium 18. Since the temperature of the heating medium 18 immediately after being returned to the heat storage unit 7 is lower than the temperature of the heating medium 18 stored in the heat storage unit 7, it is preferable to adjust the positions of the inlet and outlet of the heating medium 18 in the heat storage unit 7 such that the heating medium 18 having a relatively high temperature is supplied from the heat storage unit 7 to the ammonia synthesis unit 9.

As a method of supplying heat to the ammonia synthesis unit 9 as necessary, a method of generating heat by electric heat or the like depending on a demand for heat is also conceivable. However, this method makes it necessary to separately secure an energy source such as power, and also makes it necessary to control the generated amount of heat. When heat is generated more than necessary, energy is apt to be dissipated and lost. When surplus power is stored using a storage battery, an electricity storage material is expensive, and it is necessary to manage an electric system.

In the case of the ammonia manufacturing apparatus 10 of the embodiment, the heating medium 18 is used as means for supplying heat into the reactor 5a when the amount of the raw material gas 14 supplied to the ammonia synthesis device 5 increases. This makes it possible to store energy at a low cost and suppress energy loss.

The extent to which the supply amount of the raw material gas 14 is increased can be appropriately set. For example, assuming that the flow rate of the raw material gas 14 after being increased is 100%, the flow rate of the raw material gas 14 before being increased may be selected from a range of 10 to 90%, for example. However, the flow rate of the raw material gas 14 before being increased may be less than 10% or more than 90%. The supply amount of the raw material gas 14 may be increased over a time of, for example, about 10 minutes to 1 hour. The increase rate (increase amount/time) of the supply amount of the raw material gas 14 may be constant within a predetermined period, or the increase rate may be set as the function of a time.

The amount of the raw material gas supplied to the ammonia synthesis device 5 can be increased more quickly as compared with the case where the heat storage unit 7 including the heating medium 18 is not used. For example, when the flow rate set as the upper limit of the amount of the raw material gas 14 supplied to the ammonia synthesis step is 100%, the flow rate of the raw material gas supplied to the ammonia synthesis step can also be increased at a rate of 1.5% or more per minute. Here, the flow rate of the raw material gas supplied to the ammonia synthesis step is the flow rate of the raw material gas supplied to the ammonia synthesis device 5 when the ammonia synthesis step is operated. Even if the increase rate of the supply amount of the raw material gas 14 is further increased, the operation of the ammonia manufacturing apparatus 10 including the heat storage unit 7 can be continued by controlling the internal temperature of the reactor 5a within a range in which the ammonia synthesis reaction is maintained.

A method of controlling the internal temperature of the reactor 5a within a range in which the ammonia synthesis reaction is maintained is not particularly limited, and it is preferable to set appropriate conditions in advance. For example, a condition in which a decrease in the internal temperature of the reactor 5a is predicted is examined in advance, and when the condition is satisfied, the supply of heat due to the heating medium 18 may be started. For example, control may be performed such that a step of supplying heat from the heating medium 18 is performed when the increase rate (increase amount/time) of the supply amount of the raw material gas 14 satisfies a predetermined condition, and the step of supplying heat from the heating medium 18 is not performed when the increase rate does not satisfy the predetermined condition.

The internal temperature of the reactor 5a may be detected to start the supply of heat due to the heating medium 18 before the internal temperature of the reactor 5a excessively decreases. As a method of detecting the internal temperature of the reactor 5a, the internal temperature of the reactor 5a may be directly measured, or may be estimated from the temperature of the produced gas 15 or the like. Control may be performed such that a step of supplying heat from the heating medium 18 is performed when the internal temperature of the reactor 5a or the decrease rate (decrease temperature/time) thereof satisfies a predetermined condition, and the step of supplying heat from the heating medium 18 is not performed when the internal temperature does not satisfy the predetermined condition.

A method of storing heat in the heating medium 18 of the heat storage unit 7 is not particularly limited, and for example, when the ammonia synthesis unit 9 is operated, the heating medium 18 may be supplied to the ammonia synthesis unit 9 to store surplus heat from at least any one of the raw material gas 14, the produced gas 15, the mixed gas 17, and the ammonia synthesis device 5 and the like in the heating medium 18. Heat may be stored in the heating medium 18 from an element other than the ammonia synthesis unit 9. The heating source for storing heat in the heating medium 18 may be installed on the same site as that of the ammonia manufacturing apparatus 10, may be installed adjacent to the ammonia manufacturing apparatus 10, or may be installed away from the ammonia manufacturing apparatus 10. The ammonia manufacturing apparatus 10 preferably includes at least a part of the heating source of the heating medium 18.

Surplus power 21 of the power source 1 may be supplied to the heat storage unit 7 such that an electric heater disposed in the heat storage unit 7 can heat the heating medium 18. As a result, the surplus power 21 can be used to store heat in the heating medium 18. At least a part of the surplus power 21 is preferably the surplus power of the power generation facility 1a due to renewable energy. For example, when the amount of power generated by the renewable energy is large, surplus energy can be stored in the heat storage unit 7.

In the heating medium 18 for high temperature, lowered fluidity such as solidification at normal temperature may be caused. A method of heating the heating medium 18 by power supply can also be used to recover the fluidity of the heating medium 18 when the heating medium 18 is excessively cooled to have lowered fluidity. For example, a method of heating the heating medium 18 may be used when the operation of the ammonia synthesis unit 9 is started or when the operation is stopped for a long time.

Heat may be stored in the heating medium 18 using exhaust heat 22 of a gas turbine 8 using surplus hydrogen 19 as fuel. Examples of the surplus hydrogen 19 include a portion of the hydrogen 12 produced in the hydrogen production unit 2 and exceeding the amount supplied to the ammonia synthesis unit 9. In order to recover the exhaust heat 22 of the gas turbine 8 and heat the heating medium 18, for example, heat exchange may be performed between the exhaust gas of the gas turbine 8 and the heating medium 18. A heat transport path may be disposed between the gas turbine 8 and the heat storage unit 7 to transport heat depending on heat conduction or the movement of the heating medium. The heating medium used for the heat transport path between the gas turbine 8 and the heat storage unit 7 may be the heating medium 18 stored in the heat storage unit 7 or a heating medium different from the heating medium 18.

When the gas turbine 8 is not installed in the ammonia manufacturing apparatus 10, the surplus hydrogen 19 can also be stored in a facility such as a tank. However, an increase in the storage amount of hydrogen causes a restriction such as a large cost of a hydrogen storage facility. When the gas turbine 8 is installed in the ammonia manufacturing apparatus 10, and power is generated by the combustion of the surplus hydrogen 19, the surplus hydrogen 19 can be effectively utilized in the form of the power 20 or the exhaust heat 22 even if the capacity of the hydrogen storage facility is suppressed.

The power 20 generated by using the gas turbine 8 may be used for any power demand of the ammonia manufacturing apparatus 10 or facility related thereto. The application of the power 20 is not particularly limited, and examples thereof include one or more of electrolysis, motive power, control, communication, lighting, displaying, heating, cooling, pressurization, decompression, and air conditioning and the like.

As described above, the heating medium 18 of the heat storage unit 7 can be used to supply heat to the ammonia synthesis unit 9 when the amount of the raw material gas 14 increases. However, even in other cases, the heat of the heating medium 18 may be used when there is a demand for heat for various purposes. Accordingly, even when there is no need to supply heat from the heating medium 18 to the ammonia synthesis unit 9, the heat of the heating medium 18 can be effectively utilized.

For example, when an air separation device 3a using temperature swing adsorption (TSA) is provided as the nitrogen supply unit 3, the heating medium 18 can be used as a heating source of the TSA. An adsorbent is not particularly limited, and examples thereof include activated carbon, a molecular sieve, and zeolite. In the TSA, each of gas components can be separated by fluctuating (swinging) a temperature by using the fact that the gas components have different adsorption rates.

The heating medium 18 can be used as a heating source for maintaining the temperature of the electrolytic device 2a in the hydrogen production unit 2. The electrolytic device 2a may use, for example, a solid oxide or a solid polymer as an electrolyte. For example, it is also possible to electrolyze water at about 70 to 90° C. By electrolyzing water under relatively mild conditions, the heating medium 18 can be easily used as the heating source of the electrolytic device 2a.

In order to transport heats 23 and 24 between the hydrogen production unit 2 or the nitrogen supply unit 3 and the heat storage unit 7, a heat transport path may be disposed therebetween to transport heat depending on heat conduction or the movement of the heating medium. The heating medium used for the heat transport path may be different from the heating medium 18 of the heat storage unit 7. The heating medium to be used in the heat transport path can be appropriately selected depending on a temperature range required for the hydrogen production unit 2 or the nitrogen supply unit 3.

The nitrogen supply unit 3 applied to the ammonia manufacturing apparatus 10 is not limited to the air separation device 3a using the TSA described above, and known nitrogen supply devices can be used. The system of the air separation device 3a is not limited to the TSA, and may be pressure swing adsorption (PSA), pressure temperature swing adsorption (PTSA), or a cryogenic separation system or the like. By adsorbing gas components while fluctuating (swinging) a pressure in the case of the PSA and a pressure and a temperature in the case of the PTSA, the separation of each of the gas components becomes possible. In the case of the cryogenic separation system, nitrogen (N₂), oxygen (O₂), and argon (Ar) and the like can be separated by fractionating liquid air obtained by compressing air.

The nitrogen supply unit 3 may supply nitrogen 13 separated in a gas phase from air to the ammonia synthesis unit 9, or may supply nitrogen 13 generated by vaporization of liquid nitrogen to the ammonia synthesis unit 9. The nitrogen supply unit 3 may be a device that supplies nitrogen gas from a facility that stores nitrogen gas or liquid nitrogen.

The nitrogen supply unit 3 may be installed exclusively for the ammonia manufacturing apparatus 10, or may be used for a joint purpose of the demand of the ammonia manufacturing apparatus 10 and other demands. The installation location of the nitrogen supply unit 3 may be on the same site as that of the ammonia manufacturing apparatus 10, may be a location adjacent to the ammonia manufacturing apparatus 10, or may be a location away from the ammonia manufacturing apparatus 10.

According to the ammonia manufacturing apparatus 10 of the embodiment, even when the supply amount of hydrogen 12 and the like is greatly fluctuated, and the supply amount of the raw material gas 14 is periodically or temporarily fluctuated, the ammonia synthesis reaction can be continued to contribute to the stabilization of the operation. By periodically determining the necessity of fluctuation in the supply amount of the raw material gas 14, more accurate control can be performed. A period for determining the necessity of fluctuate in the supply amount of the raw material gas 14 is not particularly limited, and may be set within a range of 2 days or more and 3 months or less.

Next, Examples of the ammonia synthesis device 5 and the heat storage unit 7 will be more specifically escribed.

FIG. 2 shows an ammonia synthesis device 5A of First Example. The ammonia synthesis device 5A includes a reactor 34 for causing an ammonia synthesis reaction to proceed. A raw material gas 14 is introduced to the inlet side of the reactor 34, and a produced gas 15 is obtained on the outlet side of the reactor 34. When the reactor 34 is a reaction column, an inlet may be provided at the column top part, an outlet being provided at the column bottom part.

In the reactor 34, reaction units 34a, 34b, and 34c including an ammonia synthesis catalyst are disposed in one stage or multiple stages. In the column-shaped reactor 34, the reaction units 34a, 34b, and 34c are formed in a bed shape, and are filled with the ammonia synthesis catalyst. In the example shown in FIG. 2, the reactor 34 includes the three reaction units 34a, 34b, and 34c, but the number of the reaction units is not limited to three, and can be appropriately set. It is also possible to connect two or more reactors 34 in series or in parallel.

The raw material gas 14 supplied from a compressor 31 of a booster 4 to the reactor 34 can pass through a first flow path 32 passing through heat exchangers 35 and 37 or a second flow path 33 including no heat exchanger. The heat storage unit 7 includes a storage container 36 storing a heating medium 18 therein.

The heating medium 18 can be circulated between the storage container 36 and the heat exchanger 35. A flow path for transferring the heating medium 18 from the storage container 36 toward the heat exchanger 35 and a flow path for transferring the heating medium 18 from the heat exchanger 35 toward the storage container 36 may be separately disposed.

The heat exchanger 35 is a heating medium-raw material gas heat exchanger. In the heat exchanger 35, heat can be supplied from the heating medium 18 to the raw material gas 14 by heat exchange between the heating medium 18 and the raw material gas 14. The heat exchanger 37 is a produced gas-raw material gas heat exchanger. In the heat exchanger 37, by heat exchange between the produced gas 15 and the raw material gas 14, heat can be transferred from a higher-temperature produced gas 15 to a lower-temperature raw material gas 14.

During a normal operation in which the ammonia synthesis reaction smoothly proceeds, the temperature of the produced gas 15 is sufficiently high. Therefore, if the heat of the produced gas 15 is transferred to the raw material gas 14 in the heat exchanger 37, the temperature of the raw material gas 14 can be sufficiently increased. At this time, the circulation of the heating medium 18 to the heat exchanger 35 may be stopped, to omit heat exchange between the raw material gas 14 and the heating medium 18. When the temperature of the raw material gas 14 is sufficiently high, heat may be transferred from the raw material gas 14 to the heating medium 18 in the heat exchanger 35 to increase the heat storage amount of the heat storage unit 7.

Even when the amount of the raw material gas 14 supplied to the reactor 34 decreases, the raw material gas 14 may be supplied to the reactor 34 through the first flow path 32 including the heat exchangers 35 and 37. As a result, the temperature of the raw material gas 14 can be sufficiently increased.

When the internal temperature of the reactor 34 rises, the raw material gas 14 may be supplied to the reactor 34 through the second flow path 33 including no heat exchanger. This makes it possible to set the temperature of the raw material gas 14 to be lower than that when supplied through the first flow path 32 to adjust the internal temperature of the reactor 34.

The ratio between the flow rate of the raw material gas 14 supplied from the first flow path 32 and the flow rate of the raw material gas 14 supplied from the second flow path 33 may be appropriately fluctuated depending on the situation. The second flow path 33 may include quench flow paths 33a, 33b, and 33c respectively communicating with different reaction units 34a, 34b, and 34c.

When an inert component is added to the raw material gas 14, the composition of the raw material gas 14 supplied from the second flow path 33 may be different from the composition of the raw material gas 14 supplied from the first flow path 32. If the composition of the raw material gas 14 in the first flow path 32 is the same as that in the second flow path 33, it is easy to control the raw material gas 14. From this viewpoint, it is preferable to supply the raw material gas 14 to which an inert component is not added to the quench flow paths 33a, 33b, and 33c.

The quench flow path 33a is connected to the inlet of the reactor 34. The quench flow path 33a joins the first flow path 32 before the inlet of the reactor 34. As a result, the raw material gas 14 can be mixed, and then introduced into the reactor 34. The quench flow paths 33b and 33c other than the quench flow path 33a are connected to the middle of the reaction units 34a, 34b, and 34c. For example, the quench flow path 33b is connected to the middle of the reaction units 34a and 34b, and mixes the intermediate produced gas passing through the preceding reaction unit 34a and the raw material gas supplied from the quench flow path 33b. Then, the mixture is transferred to the subsequent reaction unit 34b.

As described above, since the ammonia synthesis reaction is an exothermic reaction, the temperature may tend to gradually rise from the reaction unit 34a located on the inlet side to the reaction unit 34c located on the outlet side. By supplying the raw material gas 14 having a lower temperature from the quench flow paths 33a, 33b, and 33c, the internal temperature of the reactor 34 is adjusted. The flow rates of the quench flow paths 33a, 33b, and 33c can be controlled by a valve or the like (not illustrated).

When the temperature of the reaction unit 34c located on the outlet side rises, the reaction unit 34c may be selected to directly supply the raw material gas 14 from the quench flow path 33c. When the temperature of the reaction unit 34b as the intermediate unit is high, the raw material gas 14 may be supplied from the quench flow path 33b communicating with the reaction unit 34b. When the temperature of the reaction unit 34a located on the inlet side is high, the raw material gas 14 may be supplied from the quench flow path 33a communicating with the inlet of the reactor 34.

The number of the quench flow paths 33a, 33b, and 33c illustrated in FIG. 2 is the same as the number of the reaction units 34a, 34b, and 34c, and is not limited thereto. For example, by the omission of the quench flow path 33a or the like, a smaller number of quench flow paths 33b and 33c than that of the reaction units 34a, 34b, and 34c may be disposed. Alternatively, only the quench flow path 33a communicating with the inlet of the reactor 34 may be installed to omit the quench flow paths 33b and 33c connected to the middle of the reactor 34.

When the amount of the raw material gas 14 supplied to the reactor 34 increases at a large increase rate (increase amount/time), the amount of heat capable of being recovered from the produced gas 15 is relatively small as described above, whereby the raw material gas 14 may be supplied to the reactor 34 without the temperature of the raw material gas 14 being sufficiently increased. By supplying heat from the heating medium 18 to the raw material gas 14 using the heat exchanger 35, it is possible to perform control such that the internal temperature of the reactor 34 rises without introducing the heating medium 18 into the reactor 34, thereby maintaining the normal operation.

In the case of the ammonia synthesis device 5A, the heat exchanger 35 performing heat exchange between the heating medium 18 and the raw material gas 14 can be used not only to supply heat in the heating medium 18 from the raw material gas 14 as necessary when the amount of the raw material gas 14 increases, but also to store heat in the heating medium 18 from the raw material gas 14 depending on the situation in other cases. The heat exchanger 37 performing heat exchange between the produced gas 15 and the raw material gas 14 can be exclusively used for supplying heat from the produced gas 15 to the raw material gas 14.

If the produced heat obtained by the ammonia synthesis reaction increases, the temperature of the raw material gas 14 also tends to rise due to heat exchange by the heat exchanger 37 as the temperature of the produced gas 15 rises. In addition to the method of adjusting the internal temperature of the reactor 34 by the raw material gas 14 supplied from the quench flow paths 33a, 33b, and 33c, it is also possible to suppress the temperature rise of the raw material gas 14 supplied from the first flow path 32 by storing heat in the heating medium 18 from the raw material gas 14 using the heating medium-raw material gas heat exchanger 35.

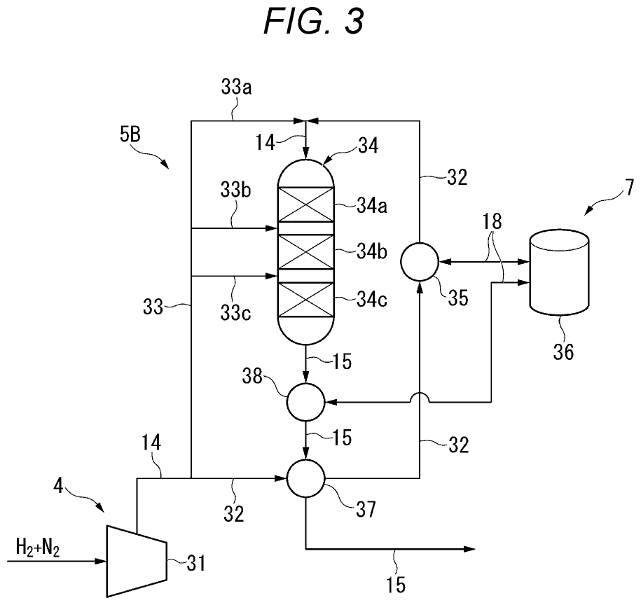

FIG. 3 shows an ammonia synthesis device 5B of Second Example. The ammonia synthesis device 5B can be configured similarly to the ammonia synthesis device 5A of First Example except that the heat exchanger 38 is installed in the flow path of the produced gas 15 between the reactor 34 and the heat exchanger 37.

The heat exchanger 38 is a heating medium-produced gas heat exchanger, and can perform heat exchange between the heating medium 18 and the produced gas 15. The heating medium 18 can be circulated between the storage container 36 and the heat exchanger 38. A flow path for transferring the heating medium 18 from the storage container 36 toward the heat exchanger 38 and a flow path for transferring the heating medium 18 from the heat exchanger 38 toward the storage container 36 may be separately disposed.

During the normal operation, the temperature of the produced gas 15 is sufficiently high, whereby if the heat of the produced gas 15 is transferred to the heating medium 18 in the heat exchanger 38, the heat can be stored in the heating medium 18 using the residual heat of the produced gas 15. Alternatively, the circulation of the heating medium 18 to the heat exchanger 38 may be stopped to omit the heat exchange between the produced gas 15 and the heating medium 18.

When the amount of the raw material gas 14 supplied to the reactor 34 increases at a large increase rate (increase amount/time), the amount of heat capable of being recovered from the produced gas 15 is relatively small as described above, whereby the raw material gas 14 may be supplied to the reactor 34 without the temperature of the raw material gas 14 being sufficiently increased. By supplying heat from the heating medium 18 to the produced gas 15 using the heat exchanger 38, the temperature of the produced gas 15 passing through the heat exchanger 38 toward the heat exchanger 37 can be increased. As a result, even if the amount of heat transfer from the produced gas 15 to the raw material gas 14 in the heat exchanger 37 is increased, which makes it possible to perform control such that the internal temperature of the reactor 34 rises even if the heating medium 18 is not introduced into the reactor 34, thereby maintaining the normal operation.

Also in the ammonia synthesis device 5B of Second Example, similarly to the ammonia synthesis device 5A of First Example, when the amount of the raw material gas 14 supplied to the reactor 34 increases at a large increase rate (increase amount/time), heat may be supplied from the heating medium 18 to the raw material gas 14 using the heat exchanger 35.

If the produced heat obtained by the ammonia synthesis reaction increases, the temperature of the raw material gas 14 also tends to rise due to heat exchange by the heat exchanger 37 as the temperature of the produced gas 15 rises. In addition to the method of adjusting the internal temperature of the reactor 34 by the raw material gas 14 supplied from the quench flow paths 33a, 33b, and 33c, it is also possible to suppress the temperature rise of the raw material gas 14 supplied from the first flow path 32 by storing heat in the heating medium 18 from the raw material gas 14 or the produced gas 15 using the heat exchangers 35 and 38.

The present invention is described above on the basis of preferred embodiments, but the present invention is not limited to the above embodiments. Various modifications are possible without departing from the spirit of the present invention. Examples of the modifications include addition, replacement, omission, and other changes of the constituent elements in the embodiments.

### EXAMPLES

The present invention will be described more specifically with reference to specific examples, but the present invention is not limited to these specific examples.

With a structure in which a heat storage unit 7 was omitted from ammonia synthesis devices 5A and 5B shown in FIG. 2 or FIG. 3, how the temperatures of reaction units 34a, 34b, and 34c and the ratio of ammonia in a produced gas 15 changed depending on a change in a flow rate at which a raw material gas 14 was supplied to a reactor 34 was analyzed by simulation.

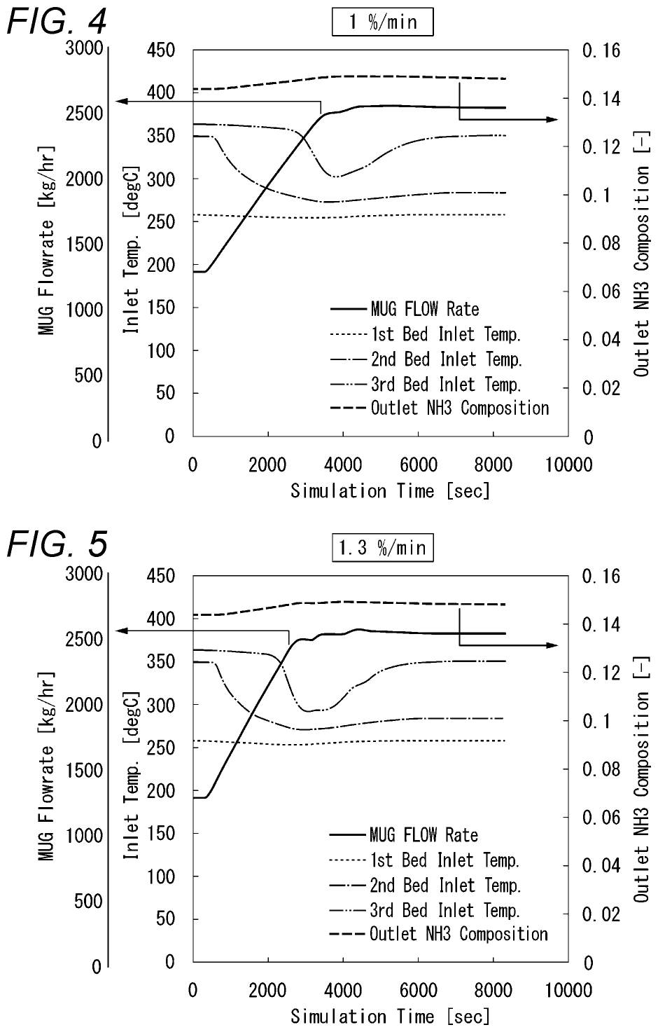

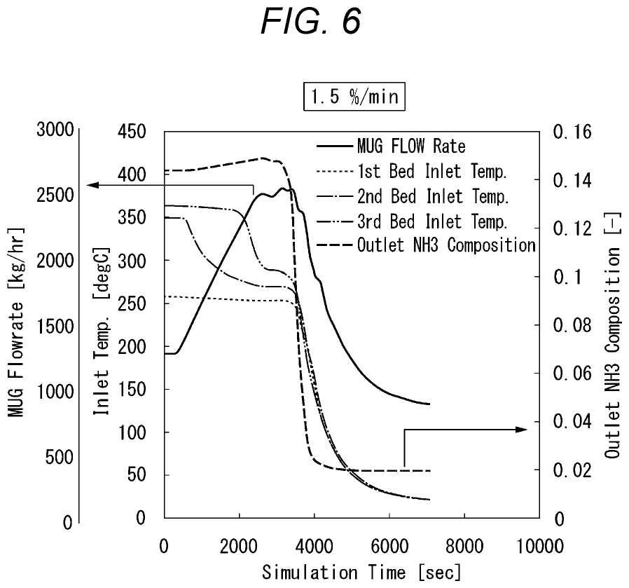

When a flow rate set as the upper limit of the amount of the raw material gas 14 supplied to an ammonia synthesis step was 100%, a process of increasing the flow rate of the raw material gas 14 supplied to the ammonia synthesis step from 50% to 100% was set as a simulation target. The increase rate (increase amount/time) of the flow rate of the raw material gas 14 was set to three kinds of 1%/min, 1.3%/min, and 1.5%/min. The results of the simulation are shown in graphs of FIG. 4, FIG. 5, and FIG. 6.

In the graphs, “Simulation Time” as a horizontal axis indicates an elapsed time during the simulation. The flow rate (kg/hr) of the raw material gas 14 is represented by “MUG FLOW Rate”. “MUG” stands for “Make Up Gas”. A region where the flow rate of the raw material gas 14 increases at a substantially constant gradient with respect to the elapsed time over about 3000 seconds in FIG. 4 and about 2300 seconds in FIG. 5 corresponds to a process of increasing the flow rate of the raw material gas 14 from 50% to 100%.

The temperature of the reaction unit 34a located on an inlet side is represented by “1st Bed Inlet Temp.”. The temperature of the reaction unit 34b as an intermediate unit is represented by “2nd Bed Inlet Temp.”. The temperature of the reaction unit 34c located on an outlet side is represented by “3rd Bed Inlet Temp.”. The ratio of ammonia in the produced gas 15 is represented by “Outlet NH3 Composition”.

As shown in FIG. 4 and FIG. 5, when the increase rate (increase amount/time) of the flow rate of the raw material gas 14 is set to 1%/min or 1.3%/min, the ratio of ammonia in the produced gas 15 is kept at a high level of about 0.15 while showing a tendency that the ratio of ammonia in the produced gas 15 increases with the increase of the flow rate of the raw material gas 14. The temperatures of the reaction units 34a, 34b, and 34c are maintained within a range suitable for the proceeding of the ammonia synthesis reaction even while the flow rate of the raw material gas 14 increases and even after the flow rate reaches 100%.

If the flow rate of the raw material gas 14 increases, the temperatures of the intermediate unit and the reaction units 34b and 34c located on the outlet side temporarily decrease, but are maintained at a certain level or more without falling below the temperature of the reaction unit 34a located on the inlet side. This is considered to be because the temperature of the raw material gas 14 is lower than the internal temperature of the reactor 34. After the increase in the flow rate of the raw material gas 14 is completed, the temperatures of the intermediate unit and the reaction units 34b and 34c located on the outlet side tend to rise due to an increase in heat produced by the ammonia synthesis reaction.

As shown in FIG. 6, when the increase rate (increase amount/time) of the flow rate of the raw material gas 14 is set to 1.5%/min, the ratio of ammonia in the produced gas 15 tends to increase with an increase in the flow rate of the raw material gas 14 at an early stage of the elapsed time. However, before the flow rate reaches 100% of the upper limit value, the ratio of ammonia in the produced gas 15 rapidly decreases. As the ratio of ammonia in the produced gas 15 decreases, the temperatures of the reaction units 34a, 34b, and 34c also rapidly decrease. As a result, finally, the temperature of each of the reaction units 34a, 34b, and 34c is significantly lower than the temperature of the reaction unit 34a located on the inlet side in the stage before the flow rate of the raw material gas 14 is increased.

This is considered to be because, as a result of an excessively rapid increase in the flow rate of the raw material gas 14, an excessive decrease in the internal temperature of the reactor 34 causes disadvantages such as unstable proceeding of the ammonia synthesis reaction. Thereafter, it is presumed that a process in which the produced amount and produced heat of ammonia decrease to further decrease the internal temperature of the reactor 34 is continued, and a catalyst is finally deactivated. Therefore, it is necessary to reduce the flow rate of the raw material gas 14 by operating a safety device.

In this type of ammonia synthesis step, in order to avoid excessive rise in the internal temperature of the reactor 34 due to the produced heat of ammonia, it is necessary to supply the raw material gas 14 to the reactor 34 while the temperature of the raw material gas 14 is low. According to the results of the simulations shown in FIG. 4 to FIG. 6, when the flow rate of the raw material gas 14 rapidly increases, the ammonia synthesis reaction unstably proceeds, which may make it difficult to continue the operation.

As shown in FIG. 4 and FIG. 5, when the increase rate (increase amount/time) of the flow rate of the raw material gas 14 is not high, it is not necessary to supply heat to the raw material gas 14. However, as shown in FIG. 6, when the increase rate (increase amount/time) of the flow rate of the raw material gas 14 is high to some extent, it is necessary to supply heat to the raw material gas 14 depending on the increase rate. That is, it is conceivable as a solution to reduce the temperature difference of the raw material gas 14 with respect to the internal temperature of the reactor 34 as necessary.

According to the ammonia synthesis devices 5A and 5B of Examples, heat can be supplied from the heat storage unit 7 to the raw material gas 14 such that the temperatures of the reaction units 34a, 34b, and 34c do not decrease even if the flow rate of the raw material gas 14 is increased. While the ammonia synthesis reaction is stable, the internal temperature of the reactor 34 is maintained by the produced heat of ammonia, so that the temperature of the raw material gas 14 does not need to be higher than the internal temperature of the reactor 34.

By using the ammonia synthesis devices 5A and 5B of Examples, even if the increase rate (increase amount/time) of the flow rate of the raw material gas 14 is increased to 1.5%/min or more, the temperatures of the reaction units 34a, 34b, and 34c and the ratio of ammonia in the produced gas 15 can be maintained. This makes it possible to stably continue the ammonia synthesis reaction.

If the internal temperature of the reactor 34 is maintained, the ammonia synthesis reaction can be stably continued. Therefore, not only the method of increasing the temperature of the raw material gas 14 but also the method of supplying heat such that the internal temperature of the reactor 34 is maintained is considered to be a solution.

### INDUSTRIAL APPLICABILITY

The present invention can be used for manufacturing ammonia using renewable energy. Ammonia can be used as an energy carrier or fuel. Ammonia can be used in manufacturing an organic nitrogen compound, an inorganic nitrogen compound, a chemical fertilizer, a chemical, and the like.

### REFERENCE SIGNS LIST

1 power source
la power generation facility
2 hydrogen production unit
2a electrolytic device
3 nitrogen supply unit
3a air separation device
4 booster
5, 5A, 5B ammonia synthesis device
5a, 34 reactor
6 ammonia separation device
7 heat storage unit
8 gas turbine
9 ammonia synthesis unit
10 ammonia manufacturing apparatus
11 power
12 hydrogen
13 nitrogen
14 raw material gas
15 produced gas
16 ammonia
17 mixed gas
18 heating medium
19 surplus hydrogen
20 power
21 surplus power
22 exhaust heat
23, 24 heat
31 compressor
32 first flow path
33 second flow path
33a, 33b, 33c quench flow path
34a, 34b, 34c reaction unit
35, 37, 38 heat exchanger
36 storage container

1. An ammonia manufacturing apparatus comprising:
an ammonia synthesis unit synthesizing ammonia under a chemical reaction using hydrogen and nitrogen as a raw material gas in a reactor; and
a heat storage unit including a heating medium,
wherein the heat storage unit can supply heat from the heating medium to the ammonia synthesis unit when an amount of the raw material gas supplied to the ammonia synthesis unit increases.

2. The ammonia manufacturing apparatus according to claim 1, further comprising a hydrogen production unit producing at least a part of the hydrogen supplied to the ammonia synthesis unit by electrolysis of water, wherein the hydrogen production unit uses renewable energy as at least a part of an energy source for the electrolysis.

3. The ammonia manufacturing apparatus according to claim 1, wherein the ammonia synthesis unit includes a heating medium-raw material gas heat exchanger capable of supplying heat from the heating medium to the raw material gas.

4. The ammonia manufacturing apparatus according to claim 1, wherein the ammonia synthesis unit includes: a heating medium-produced gas heat exchanger capable of supplying heat from the heating medium to a produced gas obtained on an outlet side of the reactor; and a produced gas-raw material gas heat exchanger capable of supplying heat from the produced gas passing through the heating medium-produced gas heat exchanger to the raw material gas.

5. The ammonia manufacturing apparatus according to claim 1, wherein heat can be stored in the heating medium using the produced gas obtained on the outlet side of the reactor.

6. The ammonia manufacturing apparatus according to claim 1, wherein heat can be stored in the heating medium using surplus power generated by renewable energy.

7. The ammonia manufacturing apparatus according to claim 1, wherein heat can be stored in the heating medium using exhaust heat of a gas turbine using hydrogen as fuel.

8. The ammonia manufacturing apparatus according to claim 1, further comprising
a hydrogen production unit producing at least a part of the hydrogen supplied to the ammonia synthesis unit by electrolysis of water,
wherein the heating medium can be used as a heating source for the electrolysis.

9. The ammonia manufacturing apparatus according to claim 1, further comprising
an air separation device using temperature swing adsorption (TSA) as a nitrogen supply unit supplying the nitrogen to the ammonia synthesis unit,
wherein the heating medium can be used as a heating source of the air separation device.

10. An ammonia manufacturing method comprising:
an ammonia synthesis step of synthesizing ammonia under a chemical reaction using hydrogen and nitrogen as a raw material gas in a reactor; and
a heat storage step of storing heat in a heat storage unit including a heating medium,
wherein the heat storage unit supplies heat from the heating medium to the ammonia synthesis step when an amount of the raw material gas supplied to the ammonia synthesis step increases.

11. The ammonia manufacturing method according to claim 10, further comprising a hydrogen production step of producing at least a part of the hydrogen supplied to the ammonia synthesis step by electrolysis of water, wherein renewable energy is used as at least a part of an energy source for the electrolysis.

12. The ammonia manufacturing method according to claim 10, wherein a flow rate of the raw material gas supplied to the ammonia synthesis step can be increased at a rate of 1.5% or more per minute with a flow rate set as an upper limit of an amount of the raw material gas supplied to the ammonia synthesis step as 100%.
